(19) United States
(12) Patent Application Publication
(10) Pub. No.: US 2016/0338331 A1
(43) Pub. Date: Nov. 24, 2016

(54) Fishing Rod Grip

(71) Applicant: Scale Pattern Fishing, LLC, Vidor, TX (US)

(72) Inventor: Jason Norsworthy, Vidor, TX (US)

(21) Appl. No.: 15/160,592

(22) Filed: May 20, 2016

Related U.S. Application Data
(60) Provisional application No. 62/164,852, filed on May 21, 2015.

(51) Int. Cl. A01K 87/08; A01K 89/00; A01K 87/06; B25G 1/10; B25G 1/02

(52) U.S. Cl. CPC A01K 87/08; B25G 1/102; B25G 1/02; A01K 87/06; A01K 89/00

(57) ABSTRACT

Embodiments provide a fishing rod assembly and apparatus.

### CROSS-REFERENCE TO RELATED APPLICATIONS

This application claims priority to Provisional Patent Application No. 62/164,852, filed May 21, 2015, which is hereby incorporated by reference in its entirety.

### FIELD OF THE INVENTION

The present disclosure relates to a rod grip, more specifically an apparatus comprising a flexible housing that may encompass at least a portion of a fishing rod.

### BACKGROUND OF THE INVENTION

The disclosed subject matter provides a rod grip. A rod grip system may comprise a flexible housing that may be positioned adjacent a fishing rod.

### BRIEF SUMMARY OF THE INVENTION

Disclosed subject matter provides an improved rod grip for a fishing rod, which may provide comfort for the user gripping the rod at the reel seat receiver. Disclosed subject matter may provide such comfort for an individual's fingers, which may hurt or may become numb after long periods of gripping a fishing rod.

The disclosed subject matter provides a rod grip apparatus. The rod grip apparatus may comprise a flexible grip housing comprising a top section, a bottom section, an interior surface, and an exterior surface. The flexible grip housing may taper to a top end and a handle end. The rod grip apparatus may further comprise a top opening extending between the interior surface and exterior surface. The top opening may be located on the top section. In embodiments, the rod grip apparatus may comprise at least one depression on the bottom section.

In embodiments, the rod grip apparatus may comprise a flattened portion on the top section.

In embodiments, the rod grip apparatus may comprise a bottom orifice that may extend between the interior surface and exterior surface. The bottom orifice may be located on the bottom section.

In embodiments, the rod grip apparatus may comprise at least one hook and loop attachment integrated into at least two edges of the flexible housing.

In embodiments, the rod grip apparatus may comprise knurling grooves located on a portion of the exterior surface.

The disclosed subject matter may further comprise a fishing rod and reel system. The system may comprise a fishing rod having a reel seat receiver. The reel seat receiver may be configured to receive a reel seat of a fishing reel. A butt handle may exist adjacent the reel seat receiver. The system may further comprise a reel having a reel seat. The reel seat may be configured to be received in the reel seat receiver for removably affixing the reel to the rod. A rod grip apparatus including a flexible grip housing may envelop a portion of the reel seat receiver, a portion of the reel seat, or both.

In embodiments, the flexible grip housing may comprise a top section, a bottom section, an interior surface, and an exterior surface. The flexible housing may taper to a top end and a handle end. The flexible housing may further comprise a top opening extending between the interior surface and exterior surface. In embodiments, the top opening may be located on the top section.

### BRIEF DESCRIPTION OF THE DRAWINGS

The novel features believed characteristic of the disclosed subject matter will be set forth in any claims that are filed. The disclosed subject matter itself, however, as well as further objectives and advantages thereof, will best be understood by reference to the following detailed description of an illustrative embodiment when read in conjunction with the accompanying drawings, wherein:

FIG. 1A displays a top view of a rod grip apparatus in accordance with an embodiment.

FIG. 1B displays a bottom view of a rod grip apparatus in accordance with an embodiment.

FIG. 1C displays a side view of a rod grip apparatus in accordance with an embodiment.

FIG. 1D displays an end view of a rod grip apparatus in accordance with an embodiment.

FIGS. 2-8 display various elements and details of alternative embodiments of a fishing rod grip as viewed from various angles.

### DETAILED DESCRIPTION OF ILLUSTRATIVE EMBODIMENTS

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

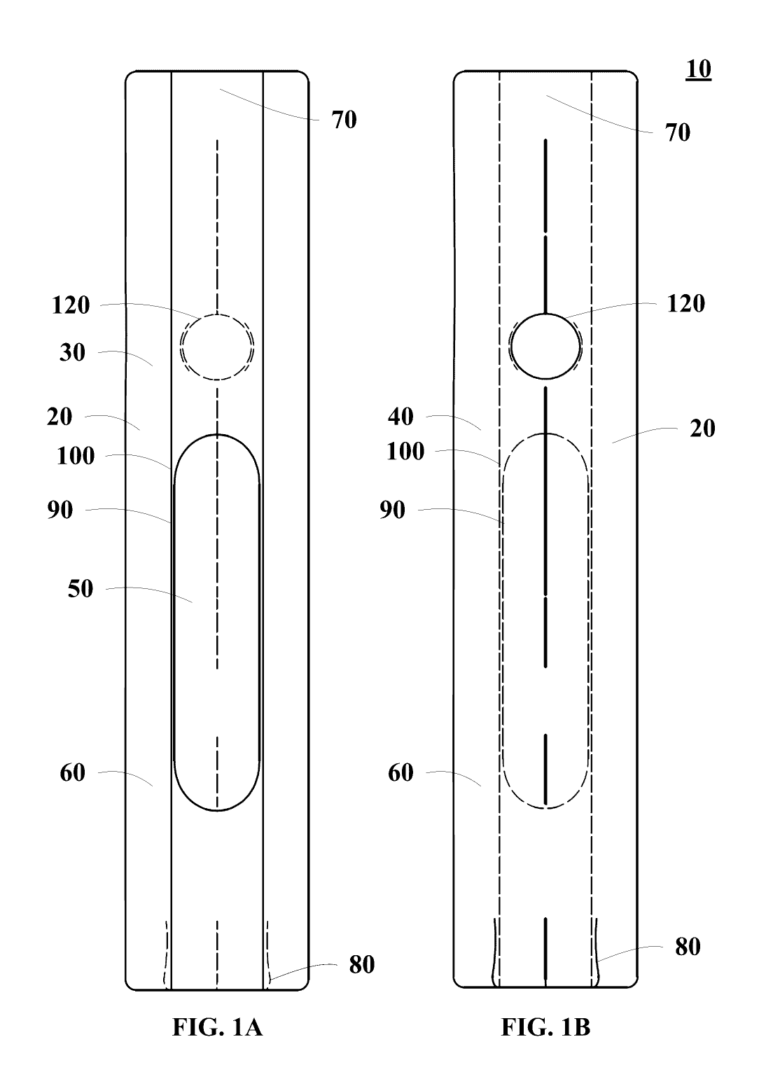

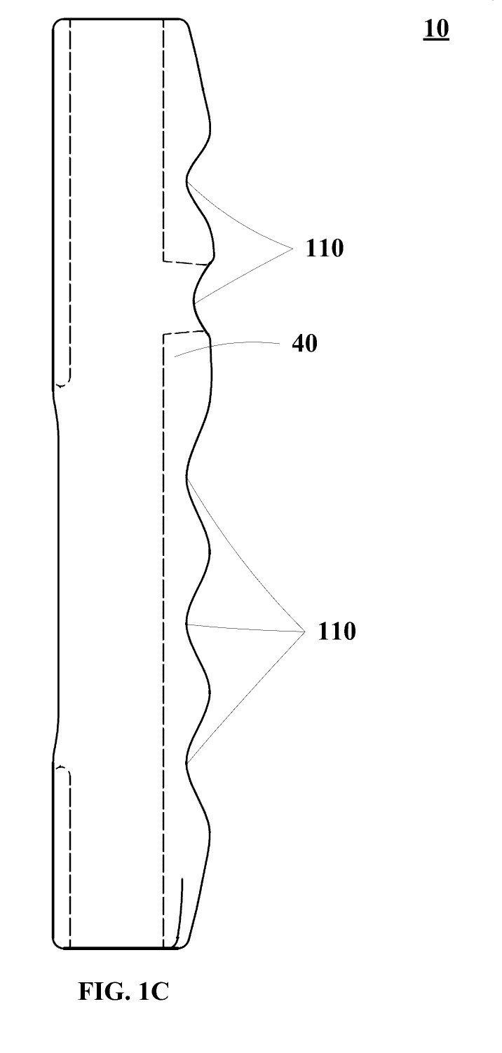

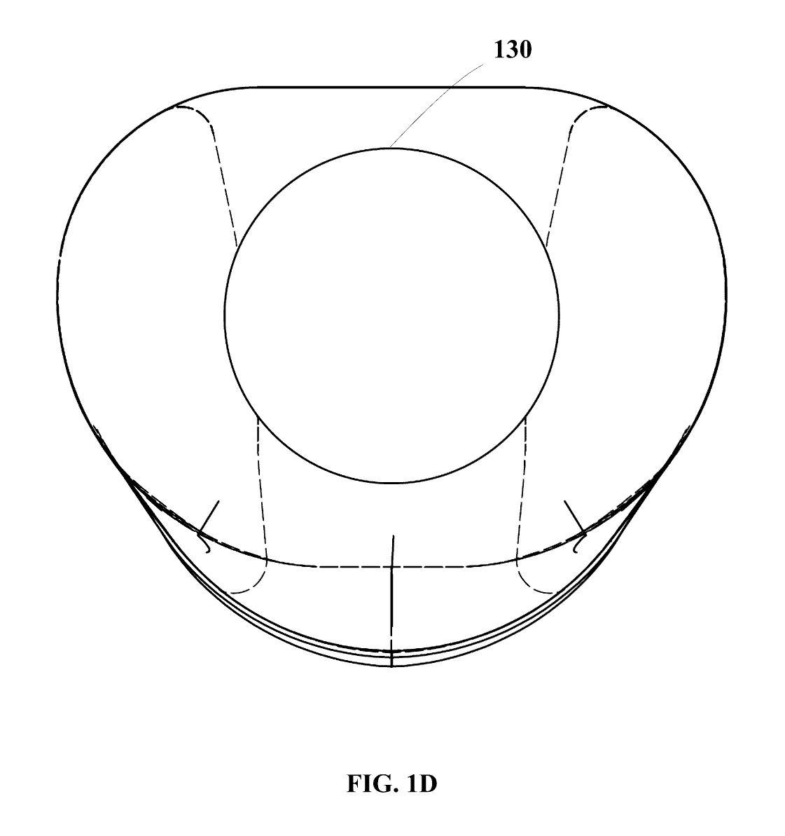

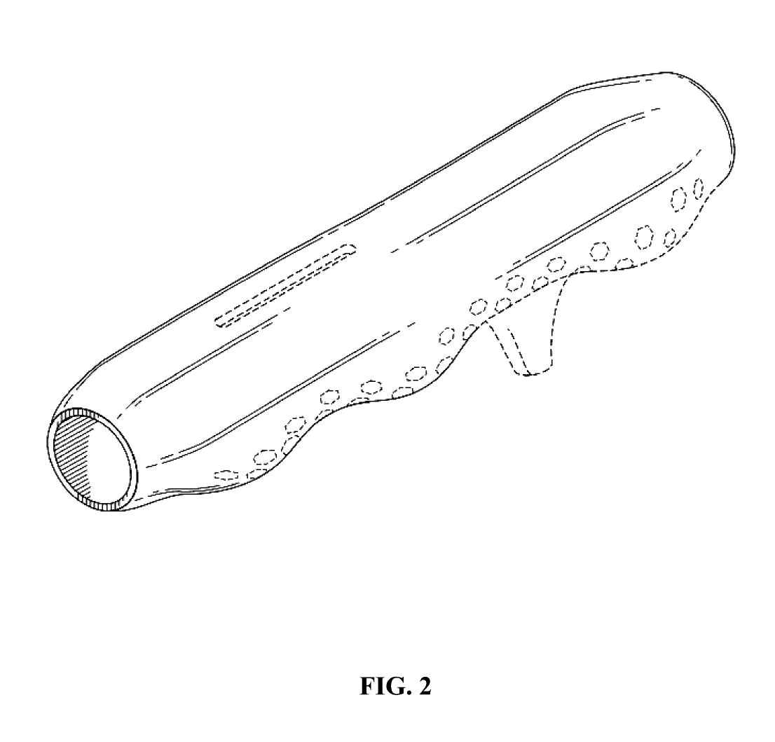

FIGS. 1A and 1B display top and bottom views of a rod grip apparatus 10 in accordance with embodiments. The apparatus 10 may comprise a flexible housing 20 including a top section 30, a bottom section 40, an interior surface 50, and an exterior surface 60. The flexible housing 20 may taper to a top end 70 and a handle end 80 (tapering shown in FIG. 1A as dotted lines at the bottom of the apparatus 10 and in FIG. 1B as solid lines at the bottom of the apparatus 10). An open interior may extend between the top end 70 and handle end 80. The apparatus 10 may further comprise a top opening 90 extending between the interior surface 50 and exterior surface 60. In embodiments, the top opening 90 may be located on the top section 30. In embodiments, the apparatus 10 may comprise a flattened portion 100 on the top section 30. The flattened portion 100 may surround the top opening 90. To clarify, the top opening 90 may be shown in FIG. 1A as a solid line and may be shown in FIG. 1B as a dotted line.

In embodiments, the apparatus may comprise a bottom orifice 120 that may extend between the interior surface 50 and exterior surface 60 (see FIGS. 1A and 1B). The bottom orifice 120 may be located on the bottom section 40. In embodiments, a finger retaining hook structure (part of a fishing rod) may exist within the orifice 120 and externally of the orifice 120 when the apparatus 10 is positioned on a fishing rod. To clarify, bottom orifice 120 is identified in FIG. 1A as a dotted line and represented in FIG. 1B as a solid line.

In embodiments, the apparatus 10 may comprise at least one depression 110 on the bottom section 40, as shown in FIG. 1C. The at least one depression 110 may be positioned on the bottom section 40. In embodiments, the at least one depression 110 may act as spaces where a user's fingers may exist. In embodiments, the at least one depression 110 may act as spaces where a user's fingers may grip the apparatus 10. In embodiments, the at least one depression 110 may comprise a texture. In embodiments, the bottom section 40 may comprise five depressions 110. Each depression 110 may provide a space for each of a user's fingers on a hand. In embodiments, the bottom orifice 120 may exist within the second depression 110 from the top end 70.

In embodiments, a substantially conical structure may be positioned in the space where the second depression 110 from the top end 70 is positioned. In embodiments, the bottom orifice 120 may be positioned on top of the substantially conical structure (see FIG. 2) to allow a finger retaining hook structure to be at least partially positioned within the substantially conical structure.

In embodiments, the rod grip apparatus 10 may comprise at least one hook and loop attachment integrated into the flexible housing 20. In embodiments, the hoop and loop attachment may be Velcro® (a registered trademark of Velcro Industries B.V.). This may allow for the rod grip system (including a fishing rod) to be affixed to a structure for storage purposes (such as, but not limited to, a wall).

In embodiments, the at least one depression 110 may comprise a knurling pattern. The knurling pattern may provide additional surface area that may act as additional contact area for an individual's hands. This may translate into increased friction between the apparatus 10 and an individual's hands. The knurling pattern may also allow for more efficient water runoff and removal from the apparatus 10 (such as, but not limited to, sweat).

In embodiments, the distance from the handle end 80 to the center of the bottom orifice 120 may measure 12/8 inches. In embodiments, the inner diameter of the flexible housing 20 may be between 7/16 inches and 9/16 inches. In embodiments, the outer diameter of the flexible housing 20 may be between 11/160 inches and 19/16 inches. In embodiments, the top opening 90 may measure 15/8 inches in length and 6/8 inches in width. In embodiments, the bottom orifice 120 may diameter.

In embodiments, the flexible housing 20 may comprise a polymeric material. In embodiments, the polymeric material may include plastic. In embodiments, the polymeric material may include rubber. In embodiments, the polymeric material may include plastic and rubber.

In embodiments, the apparatus 10 may be a sleeve. The sleeve may comprise a top section, a bottom section, an interior surface, and an exterior surface. The sleeve may taper to a top end and a handle end. The sleeve may further comprise a top opening extending between the interior surface and exterior surface. In embodiments, the top opening may be located on the top section. The flattened portion may surround the top opening.

In embodiments, the apparatus may be an article of manufacture. The article of manufacture may comprise a top section, a bottom section, an interior surface, and an exterior surface. The sleeve may taper to a top end and a handle end. The sleeve may further comprise a top opening extending between the interior surface and exterior surface. In embodiments, the top opening may be located on the top section. The flattened portion may surround the top opening.

In embodiments, a knurling pattern may be located on a portion of the exterior surface of the article of manufacture. In embodiments, the flexible housing of the article of manufacture may include a polymeric material. In embodiments, the bottom section of the article of manufacture may comprise at least four depressions.

In embodiments, the top opening of the article of manufacture may measure 15/8 inches in length and 6/8 inches in width. In embodiments, the bottom orifice of the article of manufacture may measure ⅝ inches in diameter.

In embodiments, the article of manufacture may include details, elements, measurements, etc. that apparatus 10 and or the disclosed sleeve comprises.

The disclosure may further comprise a fishing rod and reel system. The system may comprise a rod having a reel seat receiver. The reel seat receiver may be configured to receive a reel seat. A handle may exist adjacent the reel seat receiver. The system may further comprise a reel having a reel seat. The reel seat may be configured to be received in the reel seat receiver for removably affixing the reel to the rod. A flexible housing 20 may envelop a portion of the reel seat receiver.

In embodiments, the flexible housing 20 may comprise a top section 30, a bottom section 40, an interior surface 50, and an exterior surface 60. The flexible housing 20 may taper to a top end 70 and a handle end 80. The flexible housing may further comprise a top opening 90 extending between the interior surface 50 and exterior surface 60. In embodiments, the top opening 90 may be located on the top section 30.

In embodiments, the system may comprise an elongated fishing rod having a tip end and a butt end opposite the tip end. In embodiments, a handle may be adjacent the butt of the fishing rod. In embodiments, a reel seat assembly may be adjacent the handle. In embodiments, the reel foot of a reel may be seated in the reel seat assembly. In embodiments, a secondary grip member may contain the reel seat assembly. In embodiments, “contain” may refer to partial envelopment. In embodiments, “contain” may refer to full envelopment.

In embodiments, the secondary grip member may define a continuous secondary grip surface exterior at least the reel seat assembly.

In embodiments, the secondary grip member may comprise a unitary sleeve member that may fit around the reel seat assembly. In embodiments, the unitary sleeve member may have a continuous outer surface that may define a continuous secondary grip surface.

In any embodiments comprising at least one of a top end and handle end, an orifice 130 may exist at the at least one top end 70 and handle end 80 to allow for a rod to penetrate the apparatus 10. This may be shown in FIG. 1D, which shows an end of an apparatus 10 with an orifice 130.

In any embodiment, a bottom orifice 120 may not exist.

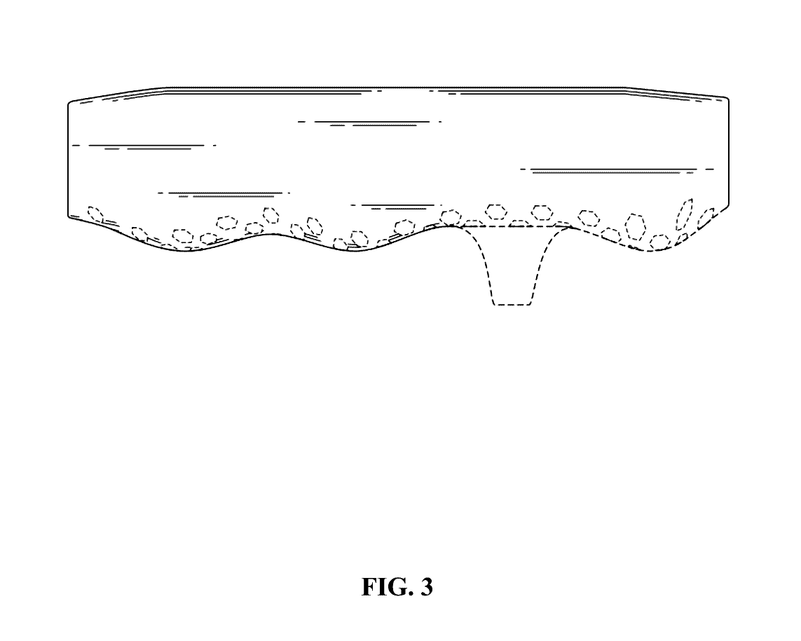

In the embodiment of an apparatus 10 found in FIG. 3, sections isolated by dotted lines may comprise at least one of a separate material, color, and texture as the section that is not isolated by dotted lines. In embodiments, sections isolated by dotted lines may also show the shape of the sections that are isolated within the apparatus 10.

In embodiments, the perimeter of the top opening 90 may fit sufficiently around the portion of a fishing rod where the reel foot meets the fishing rod. In embodiments, the perimeter of the top opening 90 may fit sufficiently around a portion of the support arm affixed to the reel foot. In embodiments, the perimeter of the top opening 90 may fit snugly around either the portion of a fishing rod where the reel foot meets the fishing rod or a portion of the support arm affixed to the reel foot to the extent that the apparatus 10 does not stretch at the top opening 90 when in use or during installation. In embodiments, the top opening 90 may be smaller in circumference than when stretched over an element of a fishing rod (such as a reel foot or a support arm). In embodiments, the top opening 90 may be expandable but may be able to return to an original circumference when not expanded.

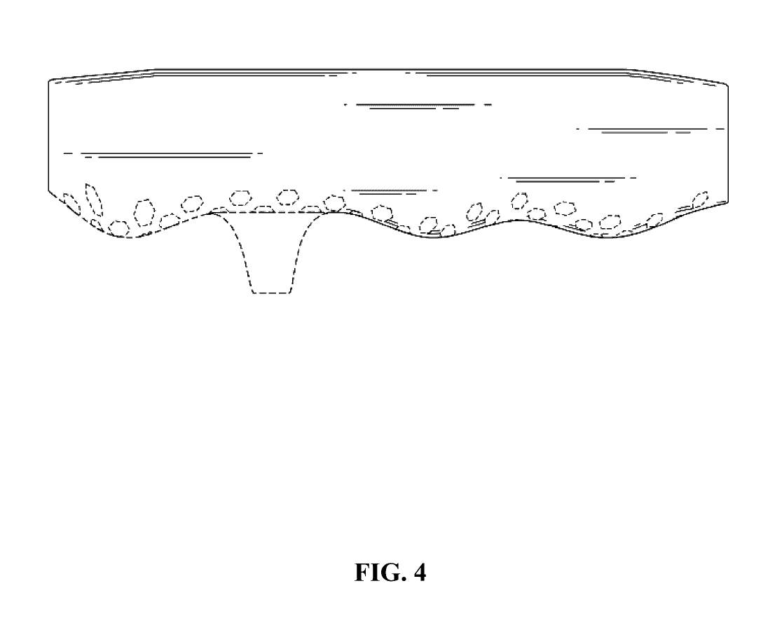

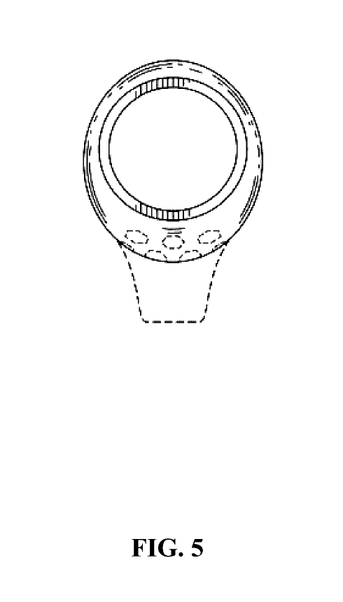

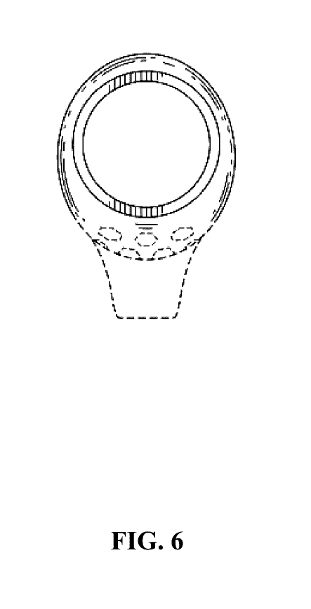

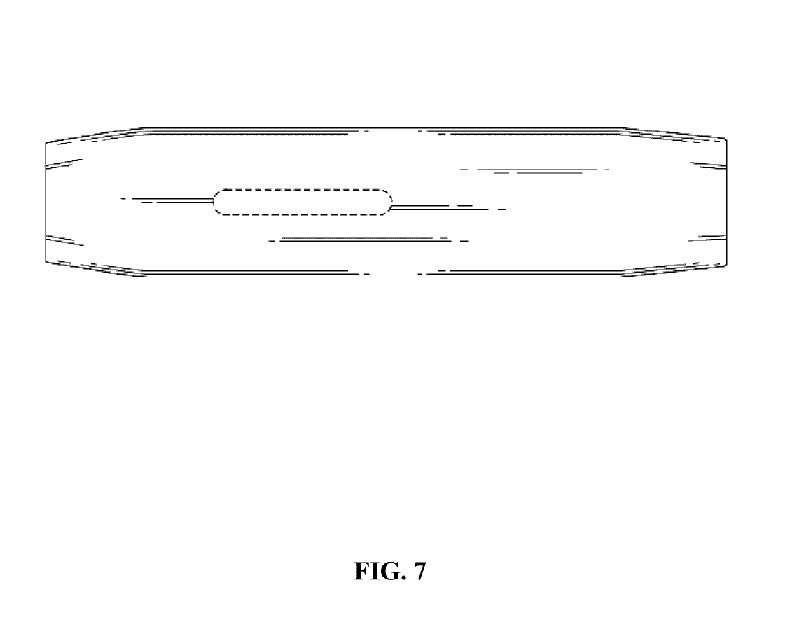

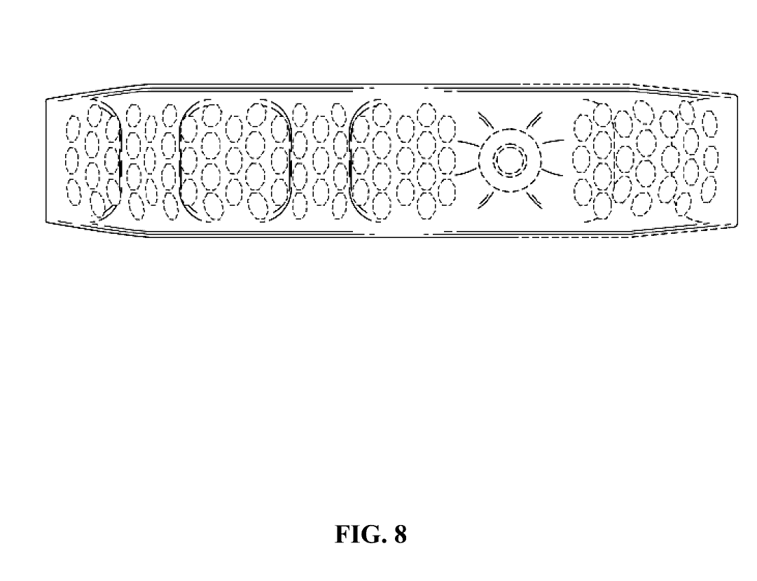

FIGS. 2-8 display various elements and details of alternative embodiments of a fishing rod grip as viewed from various angles.

For the purposes of this disclosure, the terms “secondary grip member”, “unitary sleeve member”, “fishing rod apparatus”, and “sleeve” may be synonymous.

While this disclosure has been particularly shown and described with reference to preferred embodiments thereof and to the accompanying drawings, it will be understood by those skilled in the art that various changes in form and details may be made therein without departing from the spirit of this disclosure. Therefore, the scope of the disclosure is defined not by the detailed description but by the appended claims.

1. An apparatus comprising:
a flexible housing comprising a top section and a bottom section, an interior surface, and an exterior surface, wherein the flexible housing tapers to a top end and a handle end;
and
a top opening extending between the interior surface and the exterior surface, the top opening positioned on the top section.

2. The apparatus of claim 1, further comprising at least one depression positioned on the bottom section.

3. The apparatus of claim 1, further comprising a flattened portion positioned on the top section.

4. The apparatus of claim 1, further comprising a bottom orifice extending between the interior surface and exterior surface, the bottom orifice positioned on the bottom section.

5. The apparatus of claim 1, wherein the distance from the handle end to the center of the bottom orifice measures 12/8 inches.

6. The apparatus of claim 1, further comprising at least one hook and loop attachment integrated into the flexible housing.

7. The apparatus of claim 1, further comprising a knurling pattern located on a portion of the exterior surface.

8. The apparatus of claim 1, wherein the flexible housing comprises a polymeric material.

9. The apparatus of claim 1, wherein the inner diameter of the flexible housing is between 7/16 inches and 9/16 inches.

10. The apparatus of claim 1, wherein the outer diameter of the flexible housing is between 11/16 inches and 19/16 inches.

11. The apparatus of claim 1, wherein the bottom section comprises at least four depressions.

12. The apparatus of claim 1, wherein the top opening measures 15/8 inches in length and 6/8 inches in width.

13. The apparatus of claim 1, wherein the bottom orifice measures ⅝ inches in diameter.

14. A fishing rod and reel system comprising:
a rod having a reel seat receiver, the reel seat receiver configured to receive a reel seat;
a handle adjacent the reel seat receiver;
a reel having a reel seat, the reel seat configured to be received in the reel seat receiver for removably affixing the reel to the rod;
a flexible housing enveloping a portion of the reel seat receiver, the flexible housing comprising:
a top section and a bottom section, an interior surface, and an exterior surface, wherein the flexible housing tapers to a top end and a handle end;
and
a top opening extending between the interior surface and exterior surface, the top opening located on the top section.

15. An article of manufacture comprising:
a flexible housing comprising a top section and a bottom section, an interior surface, and an exterior surface, wherein the flexible housing tapers to a top end and a handle end;
a top opening extending between the interior surface and the exterior surface, the top opening positioned on the top section;
at least one depression positioned on the bottom section;
a flattened portion positioned on the top section;
and
a bottom orifice extending between the interior surface and the exterior surface, the bottom orifice positioned on the bottom section.

16. The article of manufacture of claim 15, further comprising a knurling pattern located on a portion of the exterior surface.

17. The article of manufacture of claim 15, wherein the flexible housing comprises a polymeric material.

18. The article of manufacture of claim 15, wherein the bottom section comprises at least four depressions.

19. The article of manufacture of claim 15, wherein the top opening measures 15/8 inches in length and 6/8 inches in width.

20. The article of manufacture of claim 15, wherein the bottom orifice measures ⅝ inches in diameter.
